(19) United States
(12) Patent Application Publication
(10) Pub. No.: US 2013/0166468 A1
(43) Pub. Date: Jun. 27, 2013

(54) BUSINESS RULES-BASED DETERMINATION OF RETAIL AND WHOLESALE ALLOCATION

(71) Applicants: Timo Vogelgesang, Blieskastel-Biesingen (DE); Roman Spohn, Hermeskeil (DE)

(72) Inventors: Timo Vogelgesang, Blieskastel-Biesingen (DE); Roman Spohn, Hermeskeil (DE)

(21) Appl. No.: 13/335,651

(22) Filed: Dec. 22, 2011

(51) Int. Cl. G06Q 30/00

(52) U.S. Cl. 705/330

(57) ABSTRACT

Methods and apparatus, including computer program products, are provided for receiving, at a shipping groups module, a sales order; processing, at the shipping groups module, the sales order to determine at least one shipping group based on at least one of a plurality of rules obtained from a rules module; and generating a shipping order including the at least one determined shipping group. Related apparatus, systems, methods, and articles are also described.

### FIELD

The present disclosure generally relates to data processing and, in particular, allocating items to fulfill an order.

### BACKGROUND

Many businesses, such as fashion retail and/or wholesale businesses, are characterized by seasonal merchandise, some of which have relatively short life cycles. As such, many retail businesses have very short lifecycles requiring quick sales at an optimum price. Generally, at the beginning of the season, the shipment of new goods from suppliers/manufacturers may be pushed with an initial quantity to the stores. During any given season, a business may request replenishment based on actual store sales and on remaining stock. However, as the end of a season approaches, the remaining stock of goods in a distribution center may be cleared by running a final merchandise push and hopefully selling out, e.g., by aggressive markdowns/discounts. In some instances, this sales cycle may occur in a few weeks time. Moreover, these businesses may have very specific requirements regarding the fulfillment of orders to sustain the strategic goals of the business, such as the fashion retailer/wholesaler. Some of these goals include high customer satisfaction, revenue optimization, margin optimization, high order fulfillment rate, and the like.

### SUMMARY

In one aspect there is provided a method. The method may include receiving, at a shipping groups module, a sales order; processing, at the shipping groups module, the sales order to determine at least one shipping group based on at least one of a plurality of rules obtained from a rules module; and generating a shipping order including the at least one determined shipping group.

Further features and/or variations may be provided in addition to those set forth herein. For example, the implementations described herein may be directed to various combinations and subcombinations of the disclosed features and/or combinations and subcombinations of several further features disclosed below in the detailed description.

### DESCRIPTION OF THE DRAWINGS

In the drawings,

FIG. 1 depicts a system for determining retail/wholesale allocations;

FIGS. 2-4 depict example calculations of shipping groups;

FIGS. 5A-5B depicts examples of user interfaces used in connection with retail/wholesale allocations;

FIG. 5C depicts an example of a process for determining shipping groups; and

FIGS. 6-24 depict examples used in connection with the subject matter described herein.

Like labels are used to refer to same or similar items in the drawings.

### DETAILED DESCRIPTION

As noted above, the fashion wholesalers and retailers have some specific requirements regarding the fulfillment of orders to sustain the strategic goals of the business. These goals give rise to rules (also referred to herein as business rules) defining how ordered items should be shipped to certain customers. The subject matter describe relates to providing a system to fulfill orders based on one or more rules specific to a customer, such as a retailer and/or wholesaler.

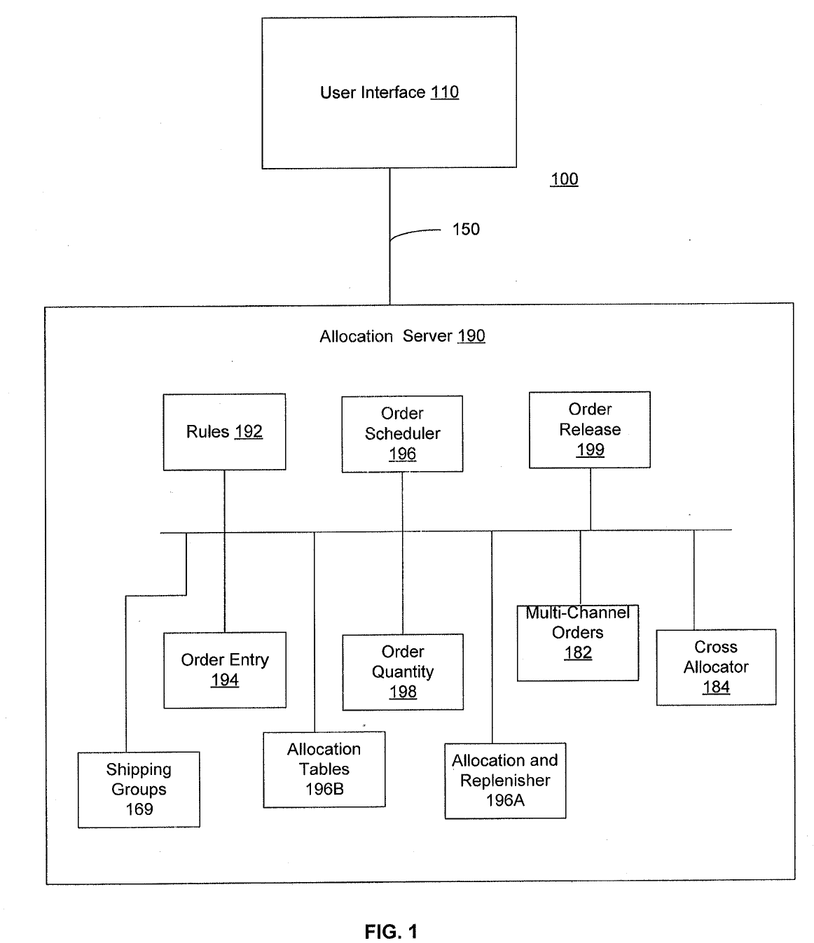

FIG. 1 depicts a system 100 including a user interface 110 coupled via a network (e.g., the Internet, an intranet, or a combination of the both) to an allocation server 190 (which may also determine shipping groups as described herein). The allocation server 190 further includes a shipping groups module 169, a rules module 192 for storing and applying rules for order fulfillment, an order entry module 194 for receiving orders entered via user interface 110, an order scheduler module 196 for scheduling orders, an order quantity module 198 for determining how many items to ship with a given order, an order release module 199 for releasing a shipment to a customer, an allocation and replenishment module 196A for allocating/replenishing orders, allocation tables 196B for storing allocation information for customers and/or items, and a cross item allocator module 184 for allocating items across styles or items. These and other modules are described further below.

As used herein, a shipping group refers a grouping by, for example, allocation server 190 of one or more scheduled line items of a sales order, so that the line item (e.g., goods, articles, and the like) may be delivered together as a group on the same date. The shipping group may be driven by rules (also referred to as business rules) maintained by rules module 192. These business rules may be defined and stored in rules module 192 and may be defined by, for example, the seller of the items and/or the end-customer purchasing the items. For example, a customer, such as a fashion retail/wholesale company, may create and store business rules in rules module 192 in order to process items of a sales order into shipping groups.

The allocation server 190 may process ordered items (e.g., items ordered by a user at user interface 110) and schedule the delivery of the ordered items. Moreover, the scheduling may be performed in accordance with the rules maintained by rules module 192. In some implementations, the allocation server 190 (and/or shipping groups module 169 therein) may reschedule items in an order and/or merge the line items to form a shipping group that satisfies and/or optimizes one or more rules of rules module 192.

In some implementations, each time a sales order is received from user interface 110, the shipping groups module 169 may re-assess shipping groups in any pending sales orders based on the rules of rules module 192. The shipping groups module 169 may determine the shipping groups in an automated manner based on the rules of rules module 192. In some implementations, the shipping groups are presented at user interface 110 as a page to allow approval by a user, such as a customer service representative, sales person, customer, and the like.

In some implementations, the rules module 192 may include one or more of the following rules: a fill rate for one or more items (e.g., a fill rate for each style and width of an item, and a fill rate across several line items); a maximum number of shipments (e.g., for any given order or sales order the maximum number of shipments of items to fulfill the order); and/or a minimum number of days between shipments for any given order. The rules maintained by rules module 192 may be configured to further take into account one or more of the following: a certain fill rate representative of how often a quantity of ordered items are provided to a retail customer for the sizes of a given item, given style, given color, and the like; an availability of a style, a color, and/or a size; a consecutive size range or a minimum number of sizes for a given style; a maximum number of shipments for individual styles and/or the complete order of the customer; a minimum days between two shipments to a customer; and/or orders for priority customers being satisfied before lower priority customers.

Moreover, the shipping groups module 169 may processes one or more rules of rules module 192 based on a trigger, such as an event. Examples of triggers include receiving or posting a sales order, processing of an electronic data interchange order, receiving an indication that a trigger has been initiated by another module of system 100, and the like.

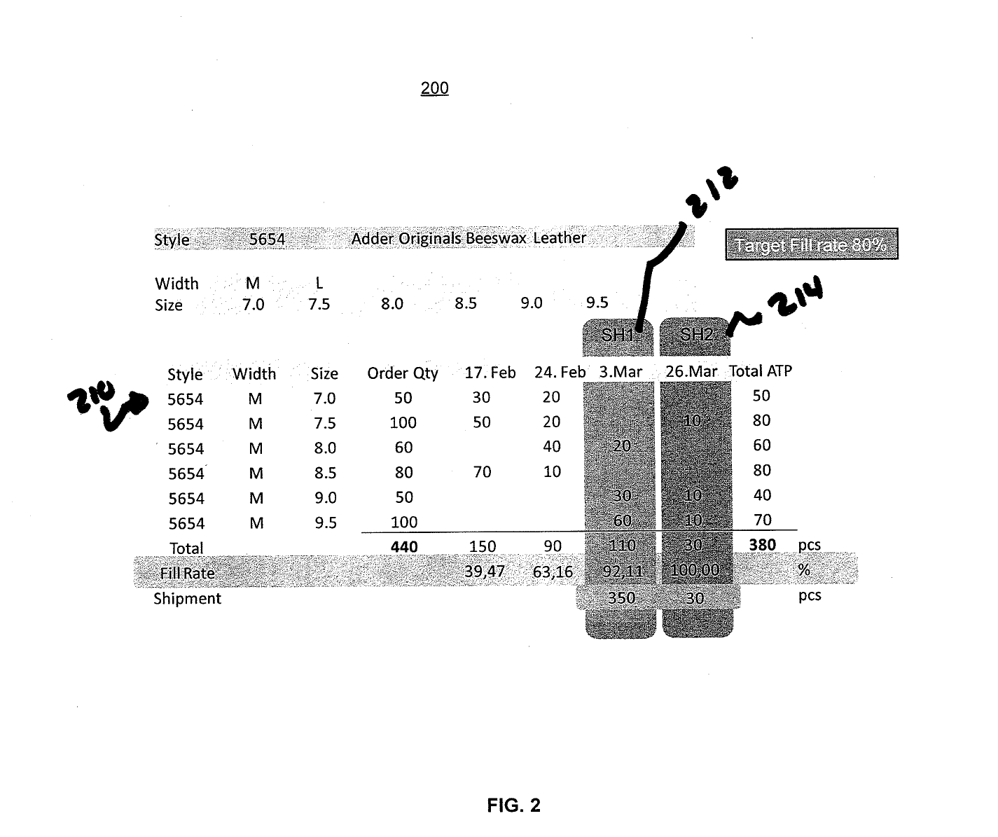

FIG. 2 depicts a page 200 with an example determination of shipping groups. Page 200 may be presented at user interface 110. A user may enter values for the items being ordered. The values may include style, width, size, and order quantity. The shipping order is presented by the user interface 110 and processed by the allocation server 190 and/or shipping groups module 169. The shipping groups module 169 may process the information at page 200 by determining, based on rules of rules module 192, fill rates for each style. For example, at line item 1 for style 5564, the fill rate to fulfill an order quantity of 50 is 30 items on February 17, and 20 items on February 24. This fill rate may be determined based on the rules of rules module 192 (which may be provided by a user via user interface 110).

The shipping groups module 169 may determine the fill rate. For example, the delivery dates may be checked by shipping groups module 169 in ascending chronological order based on the fill rate for each product on a generic measure (e.g., on “width”). In this example, all line items which contain a variant of the generic having the same “width” are processed by shipping groups module 169 together for the determination of the fill rate. The fill rate for a confirmed delivery date may be calculated by shipping groups module 169 as the sum of all of the confirmed quantities (e.g., across all sizes for the generic/width) for a certain date divided by the sum of the ordered quantities across all sizes for the generic measure (e.g., width). Starting by the earliest delivery date, the fill rates are then compared to the target fill rate for the sales order. If the target fill rate is not met, the process at the shipping groups module 169 may be repeated with the second delivery date (e.g., in ascending chronological order) and this time the sum of the all confirmed quantities (e.g., across all sizes for the generic/width) for the first two dates is divided by the sum of the ordered quantities (e.g., across all sizes for the generic/width). This process may be repeated at the shipping groups module 169 until the required fill rate is met (in which case all delivery dates before the last processed delivery date are rejected and the confirmed quantities are accumulated onto this last date) or the latest delivery date is reached and the fill rate cannot be met (in which case an exception is triggered, e.g., fill rate not met).

The minimum number of days between shipments may be determined by the shipping groups module 169 based on delivery dates across orders that are checked in descending chronological order, starting with, for example, the latest date. This check may have two possible results. First, if the difference in calendar days between one delivery date (date “n”) and the prior delivery date (date “n−1”) is less than the minimum number of days, then the delivery date “n−1” is rejected by shipping groups module 169 and confirmed quantities are added to the quantities of date “n,” and the process may be repeated by shipping groups module 169 with other dates, e.g., “n” and “n−2”. Second, if the difference in calendar days between one delivery date (e.g., date “n”) and a prior delivery date (e.g., date “n−1”) is more than or equal to the minimum number of days, then the check by the shipping groups module 169 has been successful and the process may be repeated with other dates (e.g., dates “'n−1”, and the like).

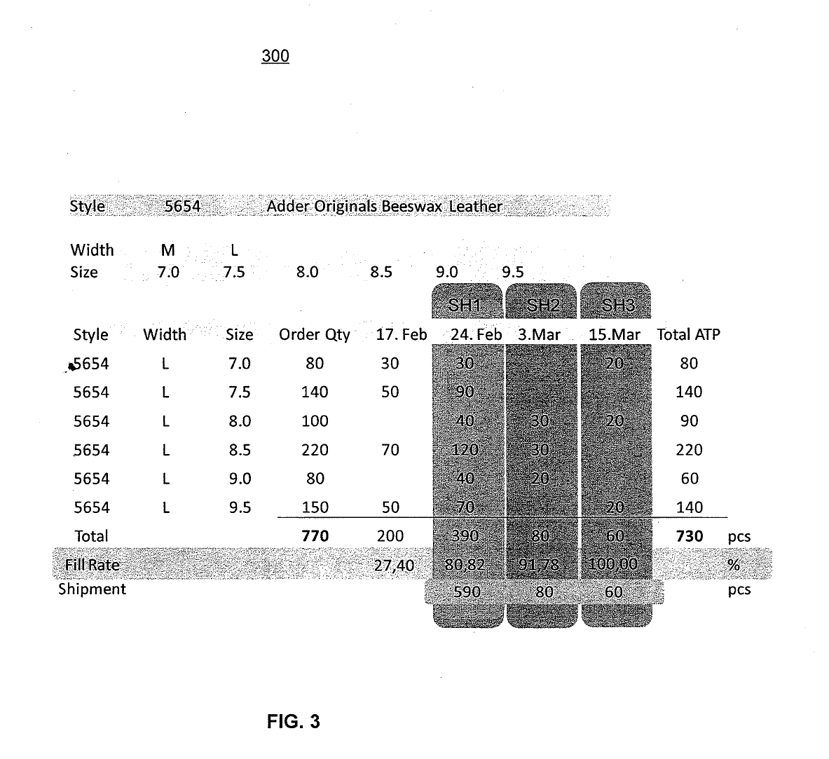

The shipping groups module 169 may determine the maximum number of shipments based on delivery dates across an order, which may be checked in descending chronological order (e.g., starting with the latest date). If the total number of shipments (e.g., the total number of different confirmed delivery dates) is larger than the maximum number of shipments, then the shipments are cumulated by the shipping groups module 169 in reverse chronological order to the latest delivery date (and this may be repeated by shipping groups module 169). Based on these rules, the shipping groups module 169 may determine, at FIG. 2, a shipping group 212 on March 3 and another shipping group 214 on March 26 and, at FIG. 3, a third shipping group on February 24.

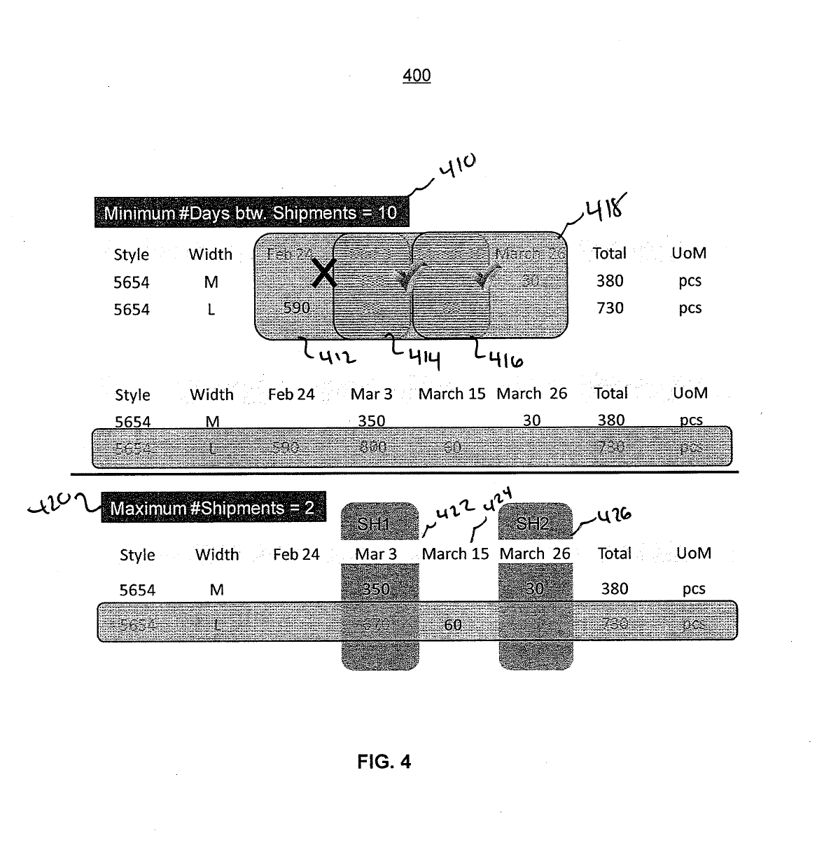

FIGS. 3 and 4 depict examples of determining shipping groups by the shipping groups module 169. FIG. 4 depicts how rules 192 are applied by shipping groups module 169 to fulfill a sales order and form shipping groups (labeled SH1, SH2m and SH8). Referring to FIG. 4, shipping groups module 169 uses a rule from rules module 192 indicating that the minimum number of days between orders is 10. In the example of FIG. 4, shipping orders 412-418 are scheduled for February 24, March 1, March 15, and March 26, so the order 412 of February 24 violates the 10 day minimum before orders rule. Based on this 10-day rule, order scheduler 196 reschedules order 412 to comply with the 10-day rule (which is stored in rules module 192). FIG. 4 also depicts a rule 420 that the maximum quantity of shipments for a given order cannot exceed 2. Here, there are 3 shipments 422-426, so one of the orders violates this 2-day rule. As such, order scheduler 196 reschedules orders to comply with this 2-day rule 420 (which is stored in rules module 192).

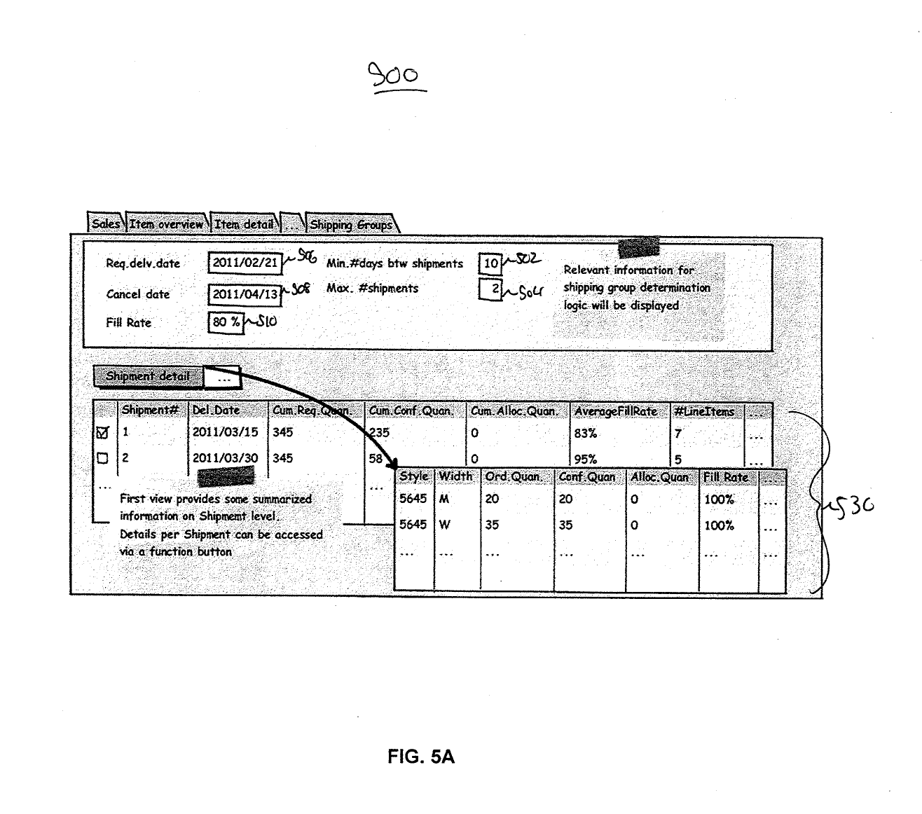

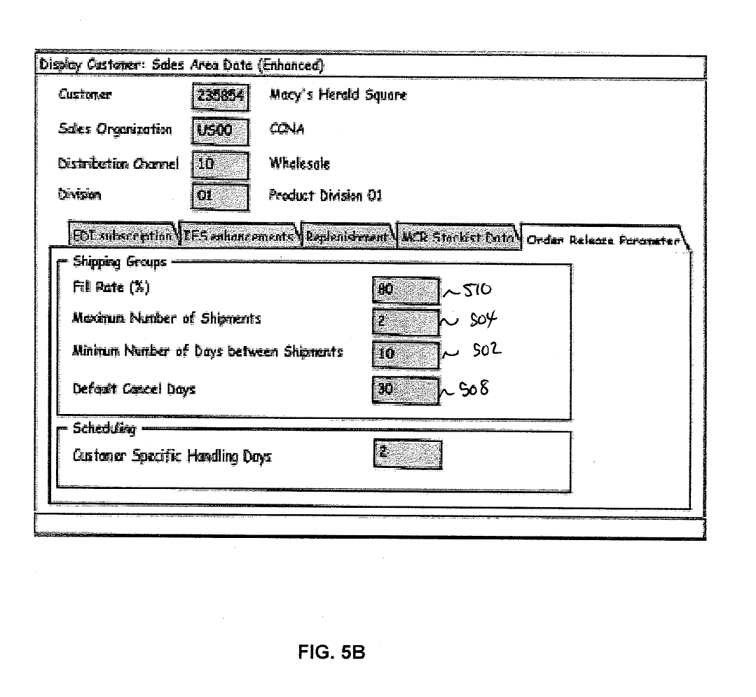

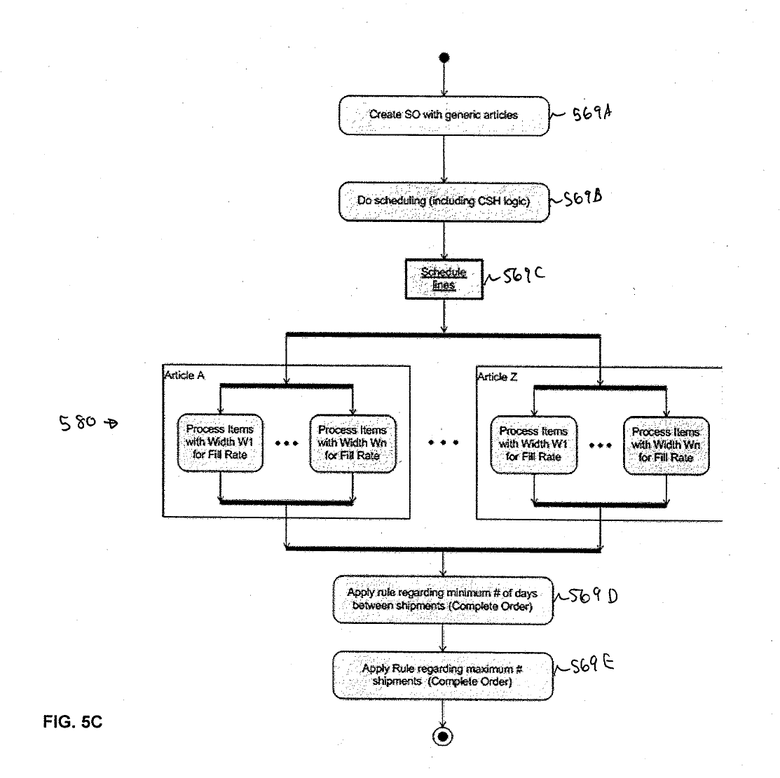

FIG. 5A depicts a page 500. Page 500 allows a user to specify rules 502-510 for rules module 192. For example, a user may enter values for a minimum number of days between shipments 502, a maximum number of shipments 504, a requested delivery date, a cancel date 508, and a fill rate 510. Page 500 also includes a summary of the order 530. FIG. 5A shows the result of the defined and applied rule set. Within page 500, the user may interactively change parameters of the predefined rule of rules module 192 if the result does not meet expectations. FIG. 5B is another example of a page (which is similar to page 500) configured to allow a user to specify rules 502-510.

FIG. 5C depicts a shipping groups process which may be implemented by shipping groups module 169. At 569A, a sales order is created with a plurality of generic articles (also referred to as items). For example, allocation server 190 may create a sales order with a plurality of items based on information received from user interface 110. At 569B, shipping groups module 169 may initially schedule the generic articles. At 569C, for each line item of the scheduled sales order, the shipping groups module 169 processes the line items at 580. For example, shipping groups module 169 may process article A of a scheduled sales order to determine a first shipping group with a width W1 and width Wn to satisfy a fill rate, shipping groups module 169 may also process article B into a second shipping group for shipment on a second date. At 569D-E, shipping groups module 169 applies rules from rules module 192 to the shipping groups to ensure the shipping groups for article A and Z comply with the minimum number of days rule and the maximum number of shipments rule. At this point, shipping groups module 169 may release the shipping groups for shipment if there are no violations of the two rules. If there is a rule violation (e.g., shipments not satisfying the minimum number of days or maximum number of shipments), the shipping groups module 169 may modify the shipping dates of the items by, for example, reallocating the articles into another shipping group.

The following describes example embodiments related to cross item allocation strategies. Cross item allocation strategies enable the allocation server 190 to allocate articles based on a calculation logic that is dependent on the allocation of other articles.

As noted, many businesses, such as fashion businesses, are characterized by seasonal merchandise, some of which have relatively short life cycles. As such, many retailers and/or wholesalers have very short lifecycles requiring quick sales at an optimum price. Generally, at the beginning of the season, the shipment of new goods from suppliers/manufacturers may be pushed with an initial quantity to the stores. During any given season, a company, such as a fashion retail store, may request replenishment based on actual store sales and on remaining stock. However, as the end of a season approaches, the remaining stock of goods in a distribution center may be cleared by running a final merchandise push and hopefully selling out, e.g., by aggressive markdowns/discounts. In some instances, this sales cycle may occur in a few weeks time. Because the sales cycle is so short, allocation server 190 may be used to satisfy the fulfillment based on rules of rules module 192 for order fulfillment. Moreover, allocation server 190 may include a cross item allocator 184 that uses rules in rules module 192 to allocate items across items (or styles) to satisfy the seasonal demands of a customer.

For example, cross item allocator 184 (labeled cross allocator) may include allocation logic to allocate items to a shipment for a customer based on, for example, colors for a given style. The allocation of colors of a style to the customers/stores is generally based on historical sales data. The allocation server 190 may run a sales analysis and may verify which colors in an article group run best in which regions and stores. The cross item allocator 184 may subsequently process temporary quantities at a given color level which is further broken down to a size by using so-called size curves generated based on historical sales. When allocating a new seasonal style to a customer's store, the cross item allocator 184 may use certain size rules (e.g., at least a minor quantity should be available for each size so that the representation of the new style in the store's floors/shelves inspires the shoppers' selling demand). Moreover, a customer may want different items allocated and fulfilled together. Such cross item allocations by cross item allocator 184 may allow fashion retailers to run a theme sales program. For example, a beachwear sales program would require cross item allocation for items such as bathing suites, flip-flops, sunglasses, tanning lotion, beach toys, and the like. As such, cross item allocator 184 may use rules in rules module 192 to ensure cross item allocation is performed to allocate these different items together.

In some implementations, the allocation server 190 including cross item allocator 184 may determine what is to be shipped and when based on rules in rules module 192 (and the corresponding cross dependencies between certain items). For example, the cross item allocator 184 may determine the allocation of products to a given entity (e.g., a retailer and the like) and may provide visibility of the range of products to be delivered (as well as align the allocation results of the interdependent products). The cross item allocator 184 may use rules in rules 192 to reconcile the interdependencies across items based on, for example, one or more of the following: individual sizes of a style/color; individual colors of a style; styles belonging to a program/theme; and styles participating in a common sales program and/or promotion.

By enabling a dynamic grouping of different items (e.g., across items), a grouping of items by cross item allocator 184 may allow shipments optimizing one or more rules in rules module 192. The cross item allocator 184 may process, based on rules 192, a group of items as a cross item allocation product group representing the dynamic grouping of products that should be processed together at the time of an allocation to a customer and/or a store. In addition, the allocation product groups may provide a business rule-driven configuration framework based on which characteristics, attributes, and combination of items are relevant to the product grouping (e.g., rules may be defined for the products groups). As a result, products that fulfill the rules and criteria may be forwarded together to the allocation and replenisher 196A calculation logic.

The cross item allocator 184 may process, based on rules 192, a group of items as a cross item allocation strategy, which comprises the calculation steps/logic/sequence in order to determine the right quantity for the right product for the right store. Thereby, the cross item allocation strategy by cross item allocator 184 may be based on one or more rules 192 to provide visibility on all the products of an allocation product group and the temporary allocation results on the items of an allocation product group.

The following describes example embodiments related to a platform for allocation and replenishment.

As noted, many businesses, such as fashion retail businesses, are characterized by seasonal merchandise, some of which have relatively short life cycles. In addition, new items (e.g., collections and styles) may be placed in the stores frequently (e.g., every 4-6 weeks). In any case, the items (also referred to as products, merchandise, and the like) are perishable in the sense that it must be sold as fast as possible and at an optimum price across one or more stores (and in some cases during the same time period). Furthermore, the merchandise may need to be presented in an attractive look and feel to appeal to shoppers. Scenario like overloaded stores and missing sizes/colors may cause discontent among consumers. In some implementations, allocation server 190 may include allocator and replenisher 196A configured to allocate and replenish based on rules in rules module 192.

In the implementations in the fashion industry, allocation server 190 including allocator and replenisher 196A may be configured to support merchandise lifecycle through its phases. High fashion styles show very similar milestones within their lifecycle and the underlying merchandise distribution process chain. An initial allocation of new styles to the stores at the beginning of the season may be followed by cyclic replenishment during the season, whereas towards the end of the season exit strategies, such as final clearance, store-to-store transfers, and price reductions/markdowns, are typical processes.

The allocation server 190 may include allocator and replenisher 196A, both of which may be configured as a unified platform for a fashion retail allocation and replenishment. Moreover, allocation server 190 may be configured to support regular allocation and replenishments based unified allocation tools, such as allocator and replenisher 196A, and user interfaces, such as user interface 110, which may be closely integrated with business analysis features used across various phases of the merchandise lifecycle.

In addition to the unification of allocation and replenishment processing and monitoring provided by allocation server 190, automated merchandise distribution scenarios may be supported. For example, a merchandiser may not be burdened with an overload of maintenance work during the business day. Instead, the merchandiser should be automatically alerted about exceptional scenarios of an allocation and/or a shipment of merchandise and then have sufficient time and appropriate tools for making the right decisions and taking the right counteractive measures. By separation of allocation processing and allocation intelligence, the fashion retail allocation may provide a framework that enables a high automation of allocation and replenishment.

Furthermore, a fashion retail allocation may provide user interfaces at 110 and tools for embedding a high degree of business intelligence into processes for allocating merchandise. As used herein an allocation table refers to a component for the central management, execution, controlling, and monitoring of allocation of items. An allocation scenario special event refers to an event that triggers the need for an allocation, for example, an initial allocation of new merchandise, a stock reduction at the end of season, etc. A key performance indicator (KPI) refers to quantifiable, key figures for measuring the progress, performance, or degree of fulfillment of objectives or success factors within the allocation business. A store cluster group refers to stores with similar characteristics and/or KPI measurements. Focused business solutions provide companies with state-of-the-art solutions that address the business priorities of very specific, small customer segments. Adaptable custom solutions refers to solutions, adapted for multiple re-use.

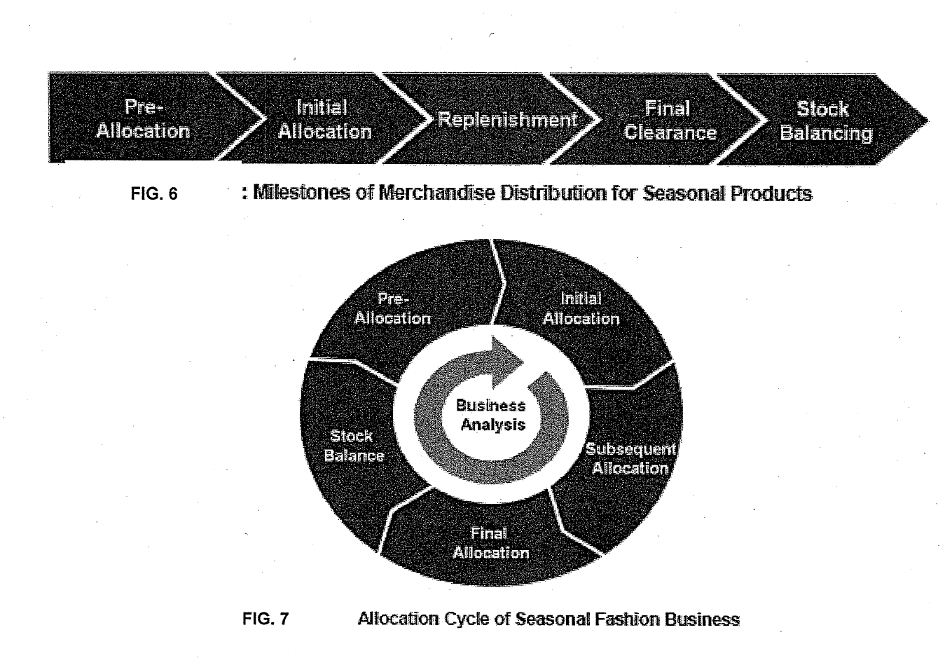

As noted, today's fashion retail business may be characterized by a growing number of seasons per year and at the same time by shortened life cycles of seasonal merchandise within the stores. Incoming new merchandise from the vendors/manufacturers at the gates of the distribution centers are pushed to the stores, then replenished based on actual store sales and finally cleared and sold out in the stores within a few weeks. Most high fashion retailers show very similar milestones within the underlying merchandise distribution process chain as depicted at FIG. 6.

### Pre-Allocation

Pre-allocation refers to the distribution of incoming new merchandise from the central to the local distribution centers based for example on the expected sales of the stores assigned to the local distribution centers. Pre-allocation is often driven by logistics aspects and logistics optimization targets, for example pre-pack optimization. Therefore, logistics cost optimization generally represents a trigger for whether to run a pre-allocation.

### Initial Allocation

Initial allocation refers to the first push of new fashion to the stores based on aspects like merchandise presentation, storage capacity of the stores, expected first week(s) sales, size quotas, etc. Some fashion retailers combine initial allocation and pre-allocation as a single allocation step so that the initial push quantities are sent to the stores directly from the central distribution center and the remaining quantities may be returned/shipped to the local distribution centers and allocated locally during subsequent store replenishment cycles.

### Replenishment

After a new item of fashion merchandise is sold in a store, replenishment supplies additional items to restock the purchased item. This is the task of replenishment, which may be considered a pull-driven process. For seasonal fashion, replenishment quantities may be calculated based on actual sales (e.g., using KPIs and simplified calculation rules). Although this is a demand-pull-driven process, it is controlled and monitored by the central merchandise department at most fashion retailers. Therefore, replenishment cycles are often called subsequent pushes and follow the control and monitoring mechanisms of allocation.

### Final Clearance

At the end of the season, the remaining stocks in the distribution center(s) are finally pushed as a final clearance to stores by a stock reduction run. The calculation of the final push quantities may be based on the actual sales performance, the still available stock in the stores, and/or store priorities. On the other hand, this life cycle phase may be accompanied by markdowns, when consumer demand has declined (and/or a large amount of unsold merchandise remains).

### Stock Balancing

Stock balancing represents the transfer of stocks between stores. At the end of a season when there is no distribution center (DC) stock available, stores that are selling well may receive additional (or remaining) item/stock from lower performing stores. This may avoid, or at least reduce, markdowns.

Allocation of seasonal fashion represents a consecutive chain of merchandise distribution milestones from a single season point of view. From a merchandiser's point of view, it's more an allocation cycle (see FIG. 7) since he/she/it might be running pre-allocation for the next season at the time when replenishment is still active for the current season. Therefore, fashion retail allocation supports, at allocation server 190, the merchandiser in daily allocation by providing unified allocation tools and user interfaces that are closely integrated with business analysis features used across the presented allocation scenarios of FIG. 7.

Tools at allocation server 190 and/or user interface 110 may provide well-directed touch points for the merchandiser into allocation processing and therefore improve the responsiveness on exceptional scenarios. Examples for such exceptional and unplanned events may include the following:
unplanned partial shipments by the vendor or manufacturer;
under deliveries;
strongly deviating shopper behavior from what has been forecasted (e.g., during prior assortment/store planning);
closure and opening of stores since the end of the purchasing period for the current season; and/or
unexpected climatic conditions for the current season.

Nevertheless, besides such exceptional events, there may be business scenarios (for example, special campaigns, rollouts, programs, and the like) that are asking for a more manually driven allocation by having the ability to verify the automatically calculated allocation results, overrule them by executing alternative allocation quantity calculations based on a different parameter/KPI set, and simulate different parameterization settings or even manually define the right quantity for the right store. Thereby, fashion retailers may follow a top-down allocation approach by starting their allocation planning at style/color and store cluster level. In subsequent planning steps, these quantities are refined and disaggregated until the lowest level of style/color/size and store is reached. This is achieved by subsequently slicing and dicing the store clusters (for example, based on regional, climate, urban, store type aspects) and at the same time by disaggregating the planned quantities at style/color down to the style/color/size level with the help of size quotas. These size quotas are generated based on sufficient actual and historical sales data and therefore provide an accurate insight into the consumer size shopping behavior. Fashion retail allocation may provide a user interface, such as user interface 110, that follows this multi-level allocation principle. The user interface may provide a hierarchical set of screens that combines the style-driven with the store-driven view on allocation following the top-down allocation planning approach. On each level, allocation quantities may be entered by the merchandiser or automatically calculated by executing a new generation of allocation strategies. Each view of an allocation strategy provides an appropriate level of information and displays the required KPIs, benchmarks, and allocation parameters used within the calculations requested by a merchandiser in order to make the right decisions.

Fashion retail allocation (as provided by system 100 and/or system 800 described below) may provide dedicated and tailored tools for the management and execution of the various allocation scenarios within the allocation cycle of seasonal merchandise (see, e.g., FIG. 7). Fashion retail allocation may be guided by one or more of the following rules:
allocation tools, services and user interfaces specialized for seasonal fashion business;
unification of processing, control and management of the merchandise distribution scenarios of the seasonal allocation cycle (see, e.g., FIG. 7);
despite unification, ability to tailor each individual allocation scenario within the allocation cycle;
seamless integration—both visual—and execution-wise—of allocation processing and allocation intelligence;
simplification by automation;
support of exception-based but also manually-driven allocation with simulation capabilities;
enablement of multi-level allocation planning; and/or
open framework for import of allocation intelligence by automated, semi-automated and manual parameterization features for KPI-based business intelligence.

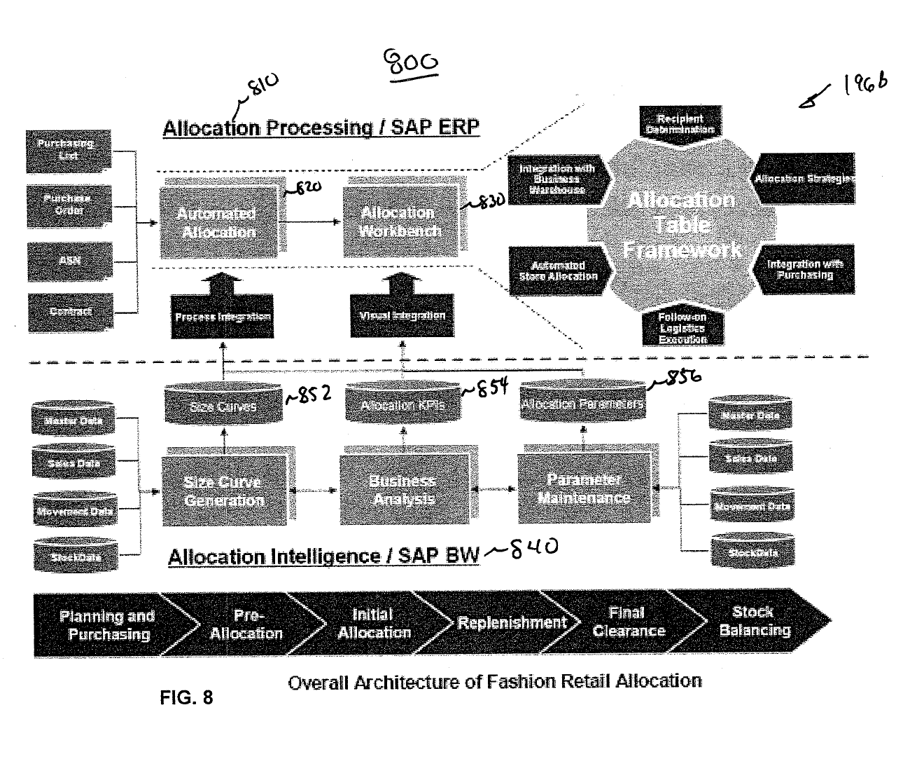

System 190 may be configured to support fashion retail allocation of items as depicted at FIG. 8. FIG. 8 depicts an allocation system 800, which may be used in connection with system 100 (e.g., as allocator and replenisher 196A). The system 800 may include an allocation processor 810 for allocation execution. The allocation processor 810 may use an enterprise resource allocation table (e.g., allocation tables 196B) and an extended service set for controlling, managing, and executing the various allocation tasks, activities, and scenarios. Allocation processor 810 may include automated allocation 820 and an allocation workbench 830.

Automated Allocation 820 enables the execution of the various allocation tasks including the creation of standard allocation tables as an automated process flow. This automated process flow may be tailored for each of the allocation scenarios (e.g., pre-, initial, final allocation, replenishment, and the like) by using the configuration facilities, services, and add-ons of the extended allocation table framework. Furthermore, a seamless integration with the an allocation Intelligence component 840 (described below) enables the embedding of allocation KPIs, allocation parameters, and size curves (e.g., sizes of an item of clothing) into the calculation and processing steps of automated allocation 820.

The allocation workbench 830 may include user interfaces (which may be presented at user interface 110) for the allocation tables as they are generated by the background processing of automated allocation 820. The allocation workbench 830 may be the centralized and unified view for the merchandiser on the allocation results for each of the allocation scenarios (pre-allocation, initial, final allocation, and/or replenishment). Nevertheless, the underlying user interface technology enables a tailoring of the screens and views for each of these allocation scenarios, so that only the relevant information is displayed for the needs of the merchandiser's current business workload. As with automated allocation 820, a seamless integration with the allocation intelligence 840 allows the visualization of allocation KPIs, parameters, and size curves as they are required by the merchandiser for the verification and benchmarking of the allocation results and for any kind of manual intervention, decision, and follow-on activity on his daily allocation workload.

The allocation intelligence component 840 may be configured as the central warehouse of the allocation business intelligence and therefore represents the intellectual property container of a fashion retailer. Allocation KPIs, allocation parameters and size curves may be manually planned or automatically/semi-automatically calculated at system 800. These calculations are based on historical sales data and by using statistical mathematical models that are unique for the allocation business of a fashion retailer and that have been fine-tuned over various business years and seasons. Such KPIs and allocation parameters are extracted by the allocation processing component 810 either for using them directly within the calculation logic for the allocation quantities or they are used as benchmarks (e.g., key figures like open-to-ship, open-to-receive, planned sales, two-week store sales performance, and the like) during the verification, review and manual allocation activities by the merchandiser. The KPIs and parameters may be updated and adjusted on a daily basis by the actual allocation and sales results in order support the merchandiser with accurate and up-to-date key figures.

The allocation workbench 830 may be configured as a single point of access for the merchandiser on the allocation workload across the various allocation milestones of the allocation cycle (see, e.g., FIG. 7). The allocation workbench 830 may not follow a document-driven approach where the merchandiser pulls the allocation workload by manually entering an allocation table number. Instead, the allocation workbench 830 may follow the push principle by automatically suggesting the relevant today's allocation workload to the merchandiser. This is achieved, by using the POWL framework (Personal Object Work List) as user interface technology, as described further below.

### Operation Allocation Queues

POWL allows the definition of operation queues. Each operation queue represents a query/selection on the allocation workload that has been generated by the automated allocation component 810 in the background. Such queries may be freely defined based on the available superset of selection criteria to build-up workloads for each individual allocation milestone of the seasonal allocation cycle (see, e.g., FIG. 7) or for exceptional allocation events, such as for example partial deliveries, rollouts, campaigns, and the like. Furthermore, each merchandiser may have its own set of allocation queues.

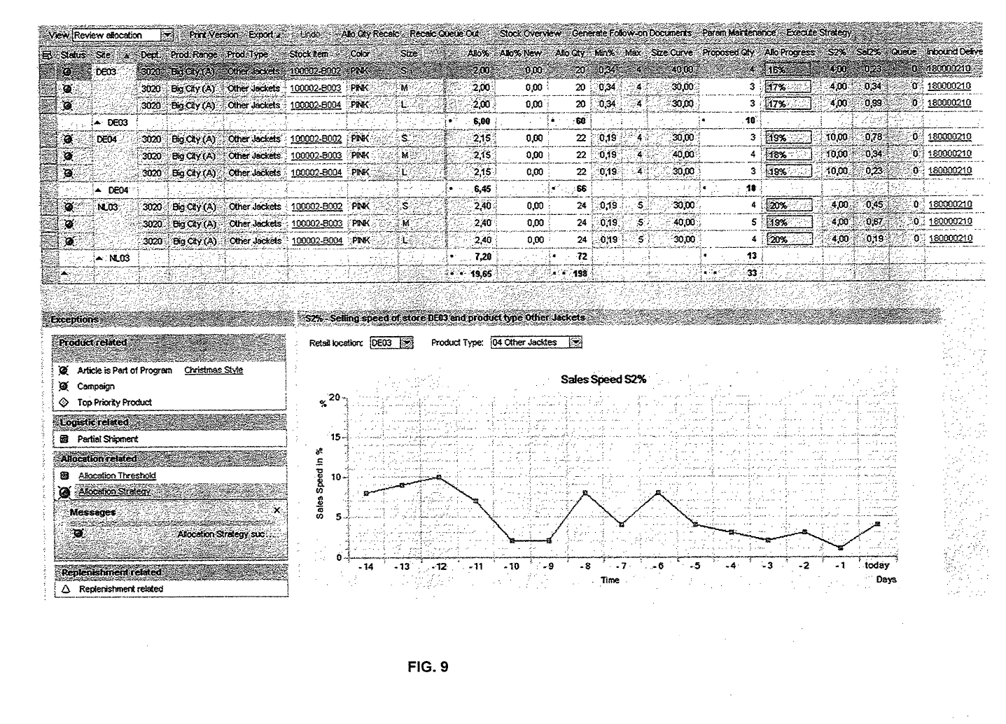

FIG. 9 depicts a user interface to enable a user, such as a fashion retailer, to manually allocate merchandise to customers/stores with the support of the following major capabilities: automatic population of pre-configured workloads to the user; multi-level allocation planning through the sales market hierarchy as well as through the article groups of the fashion company; visual integration of allocation intelligence as represented by historical key performance indicators and forecast values; graphical visualization of business performance, values and costs; and interaction and simulation tools.

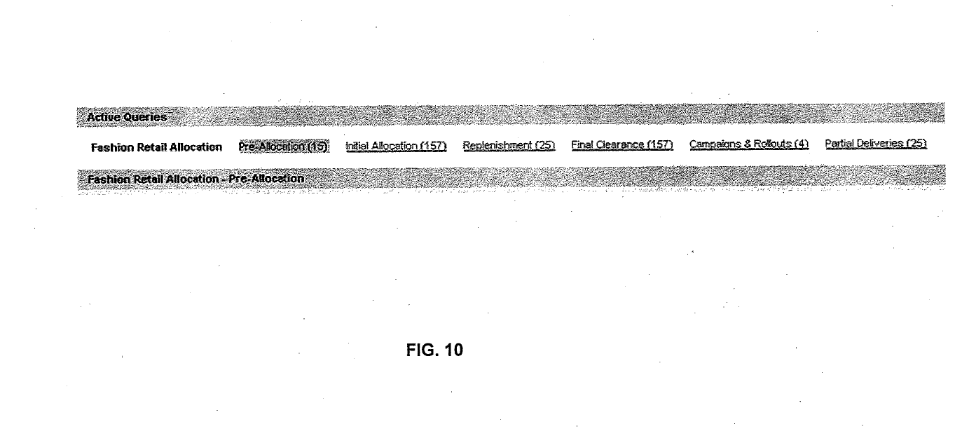

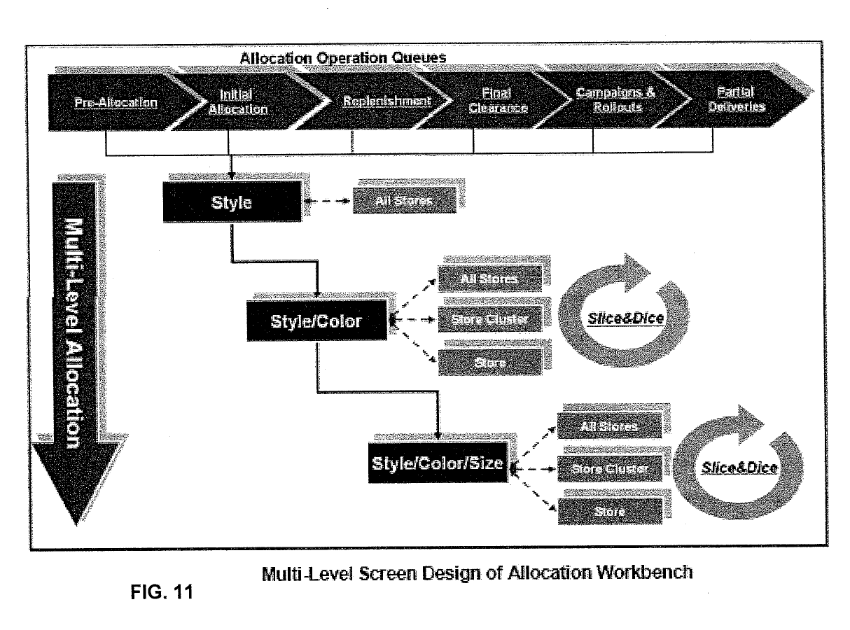

As an example, FIG. 10 shows a set of pre-defined allocation queues. There is a queue for each of the allocation scenarios. Furthermore, there is a dedicated query both for campaigns and rollouts and for partial deliveries since these events may require special attention, special views, and manual allocation interaction by the merchandiser. On clicking on one of the query links, the merchandiser reaches the list of allocation line items that are assigned to the corresponding allocation milestone/scenario/event. The volume of the allocation workload is indicated by the numbers as attached to the individual queries. For example, there are 157 allocation line items to be reviewed for initial allocation in the example of FIG. 10.

Following this principle of push-driven queues with their flexible query functionality in the background, allocation line items may be processed across several allocation tables, purchase orders, and/or inbound deliveries. This may loosen strict document flow driven approach of allocation table transactions and instead enables the allocation of styles that belong together from a merchandiser's perspective but would otherwise not be processed within the same purchasing flow. An example for such a scenario may be a special summer theme for men's beachwear. Swimming trunks, shorts, and caps may be ordered from a vendor different than the flip-flops vendor but should be allocated together with balanced quantities per color and sizes.

The allocation workbench 830 may be configured to provide a hierarchy of views (e.g., pages presented at a user interface) on the line items of an allocation operation queue. This hierarchy of screens (e.g., pages presented at a user interface) follows the multi-level allocation principle that enables a consecutive refinement of allocation results based on a multi-step top-down allocation planning approach. Thereby, multi-level allocation is mainly driven by the two dimensions of article and store. It supports views on the combination of the following allocation data levels: an article (e.g., style, style/color, and/or style/color/size) and a store (e.g., all stores, a cluster of stores, slicing and dicing, a store, and the like).

On entering an allocation queue, the merchandiser may reach the complete list of allocation line items that are assigned to the attached allocation scenario like for example initial or subsequent allocation. This initial list is at style level and therefore displays totalized allocation quantities over all colors and sizes of the styles and over all stores that are participating in the current allocation of the corresponding styles.

On selection of one single or several styles, the merchandiser may navigate top-down to the style/color view. This view displays a list of all colors of the selected style(s) together with the required allocation KPIs, parameters, master data attributes (see section 3.1.3) and editable columns for overruling the (automatically) calculated allocation quantities at color. The style/color view may be scaled in such a way that the line items represent the totalized allocation results over all stores per store cluster or for single stores. Moreover, store clusters may be refined by using the feature of so-called “slicing and dicing.” Slicing and dicing may be configured to provide a set of store attributes (e.g., region, climate zone, store type, urbanity, and the like) for dynamically creating refined store clusters. Consequently, allocation quantities may be verified and/or refined based on these on-the-fly store clusters.

The merchandiser may choose a list of style/colors and navigate down to the style/color/size level in order to review and/or update the allocation quantities for each single variant. As with the style/color view, the list of allocation line items may be scaled and sliced and diced in order to reflect all stores, store clusters, refined store clusters, or single stores. Furthermore, all the required allocation KPIs, parameters, size quotas, master data may be attached to the allocation items at style/color/size with the help of a flexible configuration framework.

Apart from these allocation recipient-based views, there may also be a view on the expected logistics workload at the supplying distribution centers. On selection of some styles, style/color or style/color/size combinations, the merchandiser may access a list of the corresponding supplying distribution centers together with the totalized allocation quantities of the receiving stores.

Furthermore, each screen of multi-level allocation may provide access to a detailed screen that opens up below the leading allocation line item list at style, style/color, or style/color/size level. On selection of an allocation line item, this detail screen shows a so-called tab rider with containers for displaying allocation processing and intelligence data including the graphical visualization of embedded allocation analytics.

For making the right allocation decisions, the relevant business key figures may be selected by a so-called click at a user interface accessing the allocation workbench 830. The multi-level allocation screen hierarchy may be configured as an open user interface platform that allows the visual integration of the allocation intelligence located in a business warehouse. This visual integration may include one or more of the following allocation intelligence objects: allocation KPIs; allocation parameters; size quotas; and embedded analytics.

Allocation KPIs may be pre-calculated or calculated on demand by executing a query on other business warehouse key figures. Typical examples for such allocation KPIs in fashion retail business are the following store-related key figures:
open-to-ship (OTS)/Open-To-Receive (OTR);
sales-based key figures like average weekly sales, x-weeks sales, sell through percentage, actual range of coverage, sales percentage on overall company sales; and/or
planning key figures like store plan and planned sales.

Allocation KPIs may be used in the calculation sequences of the allocation strategies and/or as benchmarks/alerts/performance indicators during the merchandiser's verification/review steps.

In comparison to KPIs, allocation parameters may be more static and do represent allocation master data that are especially used in the calculation logic of the allocation strategies. Allocation parameters may be maintained manually and/or semi-automatically calculate value proposals. The maintenance of allocation parameters may have an underlying data level hierarchy (e.g., based on the article hierarchy) that enables a maintenance on higher coarse-grained but also lower fine-grained data levels. Typical examples for such allocation parameters include the following: a maximum quantity, a maximum percentage; a minimum quantity, a minimum percentage; a target time of supply; a target range of coverage; and/or a minimum picking quantity.

Size quotas may be automatically generated based on historical and actual sales data by a size curve engine in a business warehouse. The allocation logic of fashion retailers may be very much color-driven. In a first step, allocation quantity quotas may be calculated based on color criteria. Next, the allocation quantities may be disaggregated from the color down to the size level by applying size quotas within the allocation strategies as they are integrated in automated allocation 820 and multi-level allocation.

Embedded analytics may be configured to allow both a graphical and time-based consideration of allocation KPIs. The allocation KPIs may be visualized as a time series so that the merchandiser may review the performances, trends, and progressions over a certain time interval and not only base decisions on snapshot values of allocation KPIs.

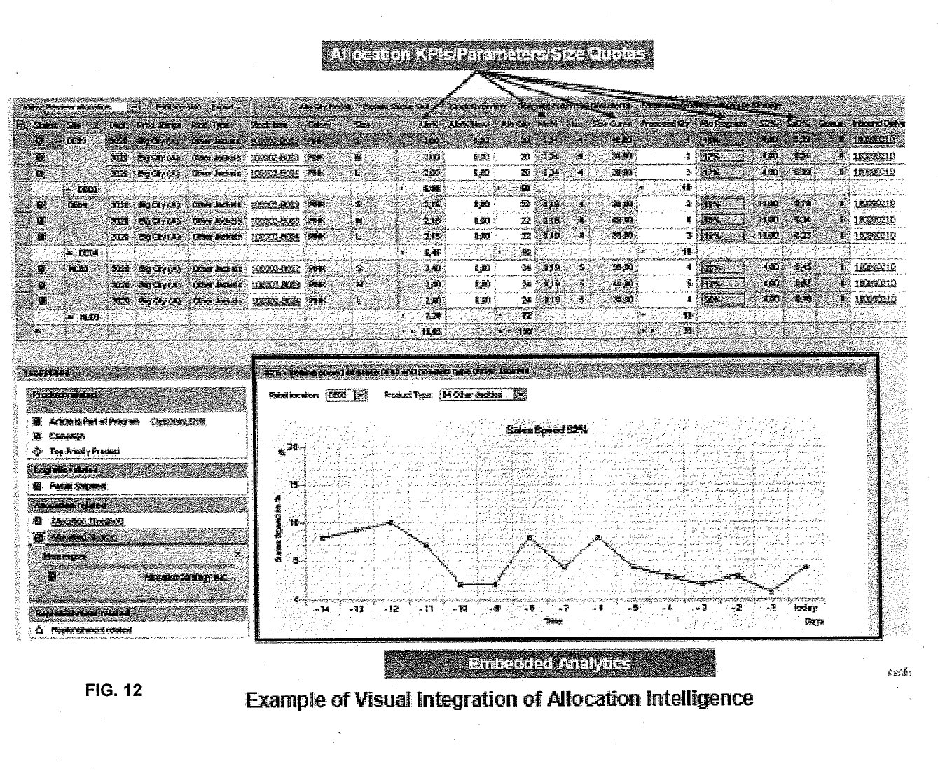

Fashion retailers envision their allocation business as being unique and a factor for overall business success. In fact, every fashion retailer has its own allocation KPIs and parameters although they are often quite similar and only deviating somewhat. Therefore, the allocation workbench 830 may provide a flexible, open user interface and configuration framework in order to visualize the allocation intelligence 840 as located in a business warehouse. The multi-level allocation screens (also referred to herein as pages, views, and user interfaces) foresee freely definable data containers on which the allocation intelligence objects may be visualized (see, e.g., FIG. 12). The list of allocation line items at style, style/color and style/color/size level on the multi-level allocation screens provide freely definable columns for visualizing allocation KPIs, allocation parameters and size quotas. Furthermore, the detail views of the multi-level allocation screens provide containers for embedding the requested business intelligence analytics as set-up in data warehouse (e.g., SAP's Business Information Warehouse).

For each business intelligence object, the configuration framework provided by system 800 enables the definition of technical and logical details like data source, data access level, access type, selection criteria, location of visualization, naming/column headings, and the like.

As a central allocation cockpit for the merchandiser, the allocation workbench may provide a plurality of interaction and navigation facilities on the multi-level allocation screens. The underlying POWL and other user interface technology may provide features for the merchandiser's daily work including one or more of the following: static and dynamic filtering on any column of the screen list; sorting on any column of the corresponding screen list; pre-defined calculation logic on columns: calculation of total, sub-totals, minimum, maximum and mean values; tailoring of screens by choosing the right information level (layouts) out of the superset of available columns; personalization by having the ability to set-up own layouts (column set, default sorting and filtering settings, etc.) for each merchandiser and each of his/her allocation queues; and print version configuration in case the merchandiser needs some print-outs for meetings.

Furthermore, navigation and execution features may be included as well. Examines of navigation and execution features include: execution of alternative allocation strategy; execution of alternative allocation recipient determination; access to detailed data screens for a selected line item in one of the multi-allocation views; navigation to relevant purchasing documents based on which allocation line items have been created; purchase order, inbound delivery, purchasing list, and/or contract; navigation to stock overview both at the stores and distribution centers; navigation to article master; execution of follow-on document generation (e.g., for stock transfer orders, outbound deliveries, etc.) for a selected list of allocation line items; navigation to follow-on documents (e.g., for stock transfer orders, outbound deliveries, etc.); and/or access and review of exception log(s).

The merchandiser may also manually enter and override calculated allocation quantities at each level of the multi-level allocation screen hierarchy. There is a disaggregation logic in place in order to (e.g., on-demand) distribute manually maintained allocation values at higher levels top-down to the lower levels.

The allocation queues of the allocation workbench 830 may be populated with allocation line items by the processing component of automated allocation 820 for fashion retail allocation. The automated allocation 820 includes automated store allocation.

Automated store allocation represents a so-called adaptable custom solution (ACS) that is enhanced by additional functionalities for the purpose of the fashion retail allocation. Automated store allocation may be configured to automatically generate allocation tables for scenarios, such as the creation of allocation table with reference to purchase order, creation of allocation table with reference to inbound delivery (ASN), creation of allocation table with reference to contract, and/or creation of allocation table based on remaining discounted stock.

Automated store allocation enables the concatenation of individual allocation tasks as an allocation processing chain and provides a high flexibility with the help of a great variety of control and selection parameters. Based on this feature set, background jobs are scheduled that are pick-up the above reference documents at the right point of time (e.g., a given number days before expected delivery date) and that execute recipient determinations, allocation strategies and other allocation sub-tasks tailored for the needs of the underlying scenario of the allocation cycle (see, e.g., FIG. 7).

### Transaction WA10

The automated allocation 820 includes automated store allocation and may also include a so-called standard transaction WA10 to enable the generation of allocation tables based on the merchandise planning results that have been achieved by the planning sessions for the current or forthcoming season some weeks/months ago and that have been the basis for the purchasing of the fashion merchandise. These planning results may be imported into other tools. The purchasing list together with the seasonal purchase order or inbound delivery represent the data source for the automated generation of allocations with the help of transaction WA10. Either allocation quantities are defined based on the planned quantities as stored in the purchasing list, or an allocation strategy may be re-executed since the fashion market, consumer trends, store portfolio, and the like might have changed since the planning period of the current/forthcoming season some months/weeks ago.

With the help of these two allocation table generators, automated allocation 820 allows the scheduling of background jobs that detect the different types of reference documents and trigger the appropriate allocation determinations and calculations in order to finally populate the allocation queues of the allocation workbench 830 with accurate allocation results that may be verified, overruled and/or improved by the merchandiser during his/her working hours afterwards. This automated allocation processing flow also includes the extraction of allocation KPIs, parameters, and size quotas that are requested by the calculation of the allocation quantities as the major objective of the allocation strategies. In FIG. 8, the process between allocation processing 810 and allocation intelligence 840 of retail fashion allocation are integrated.

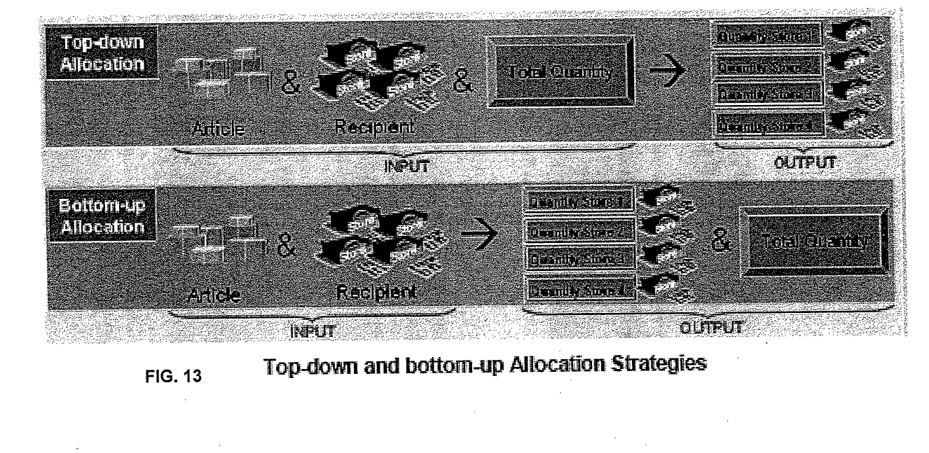

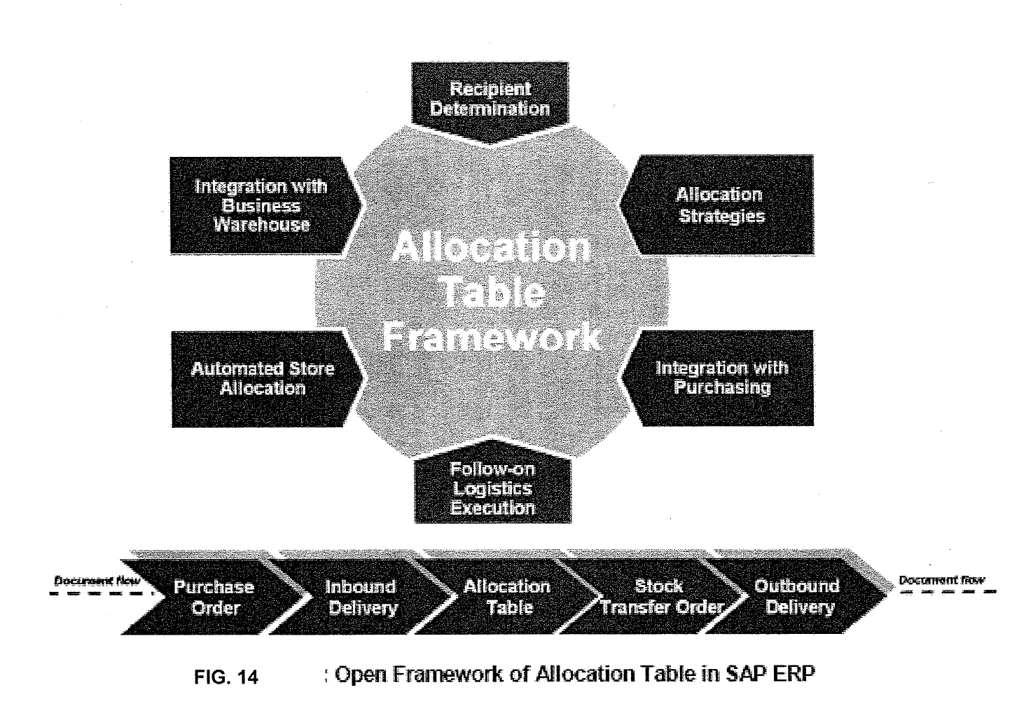

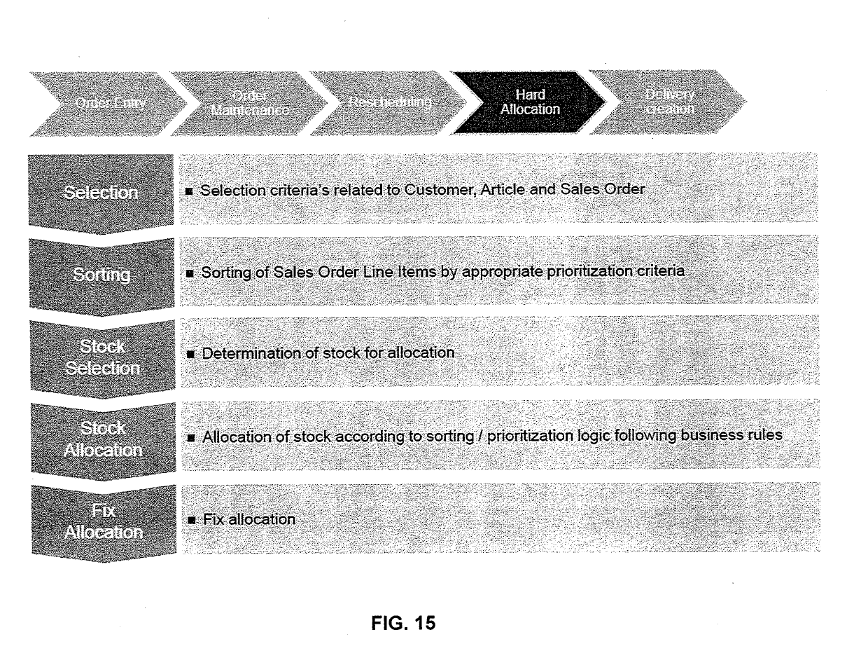

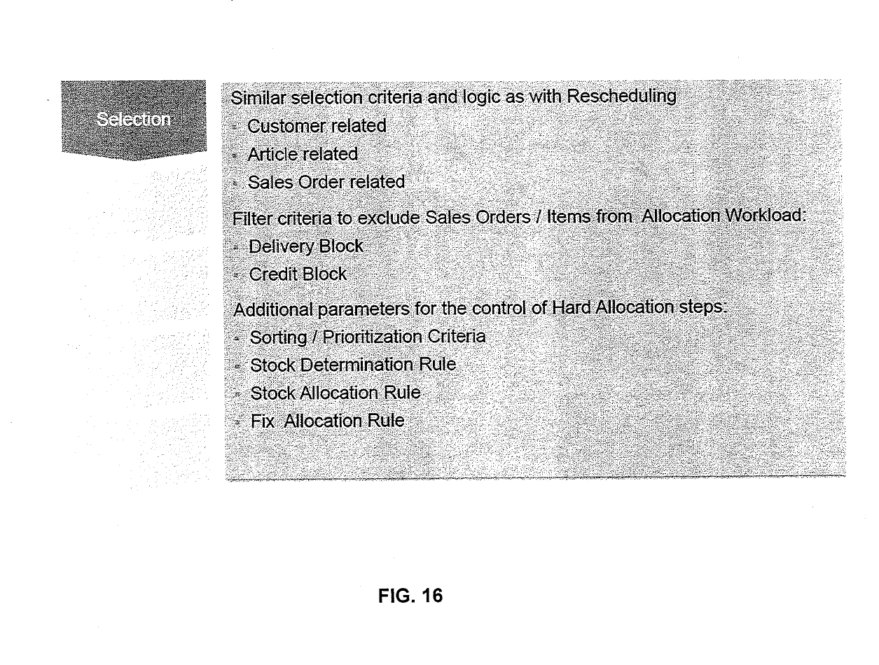

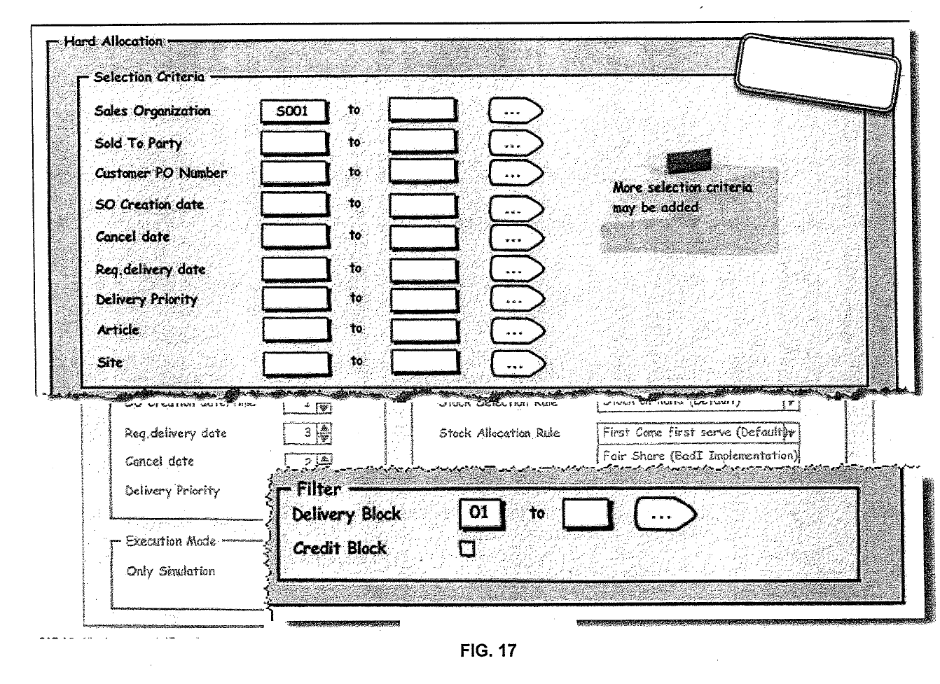

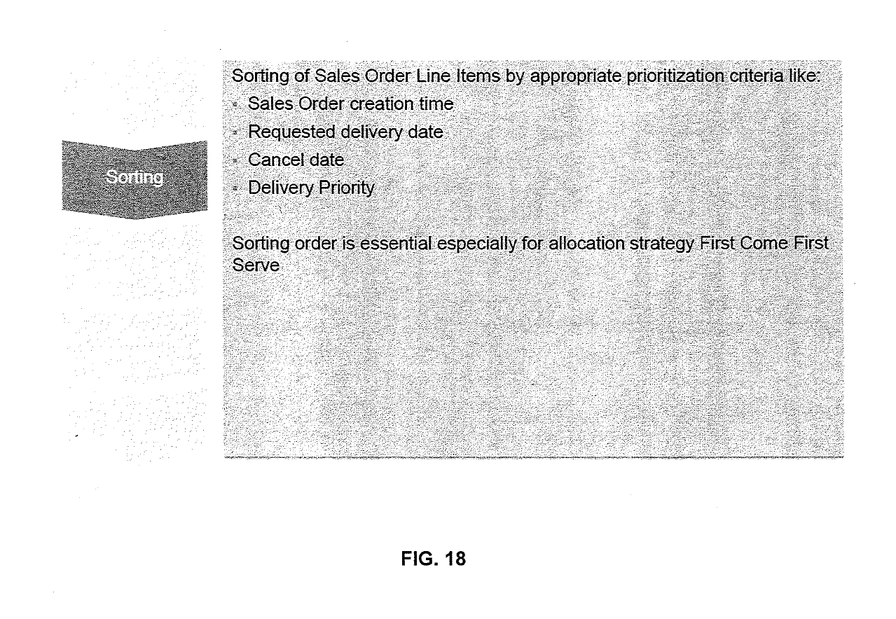

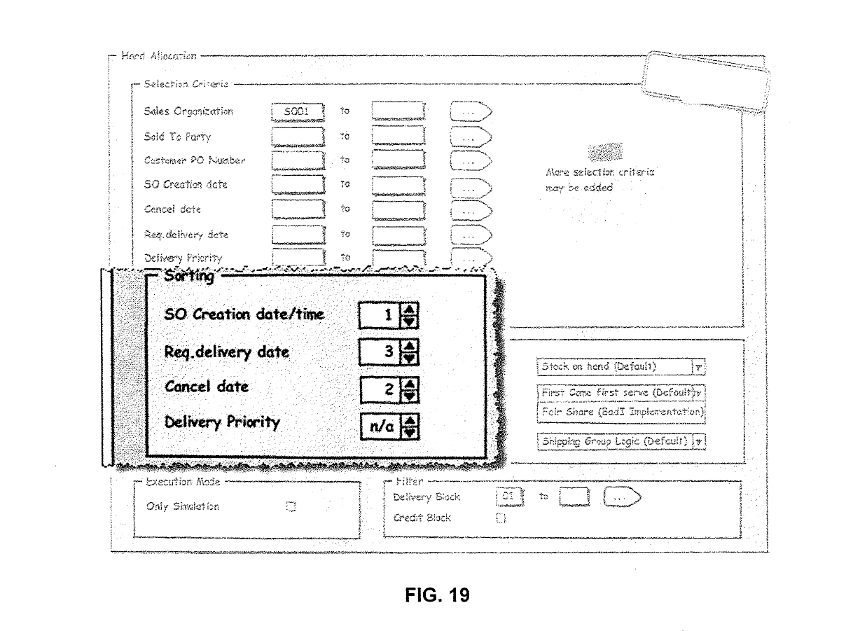

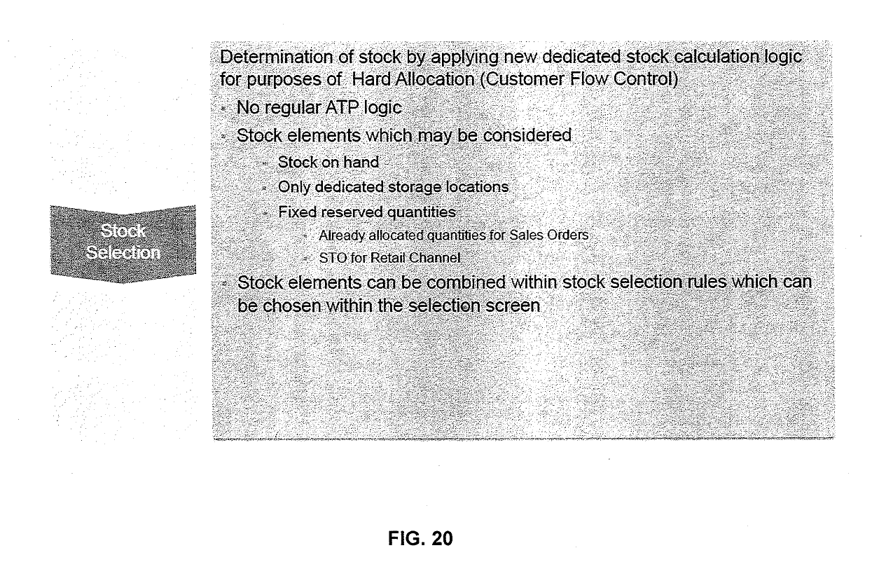

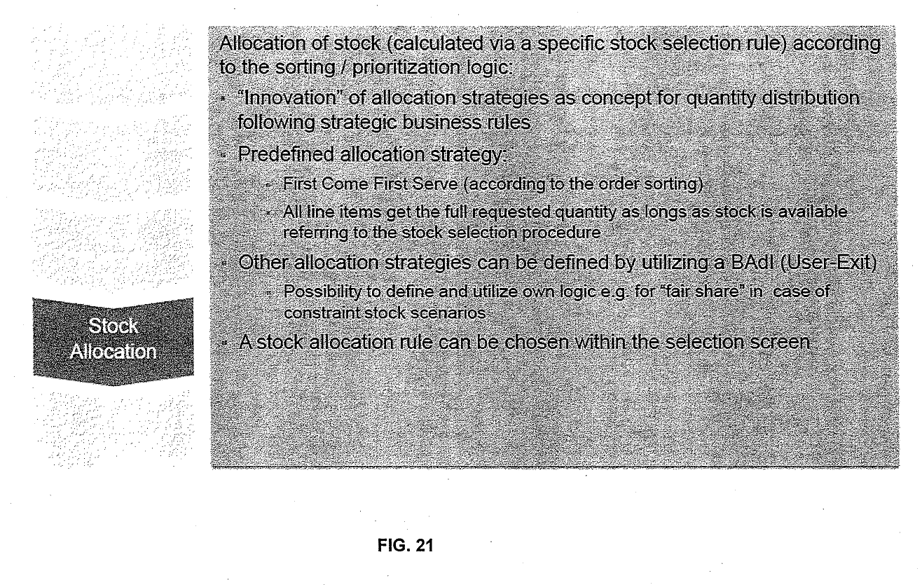

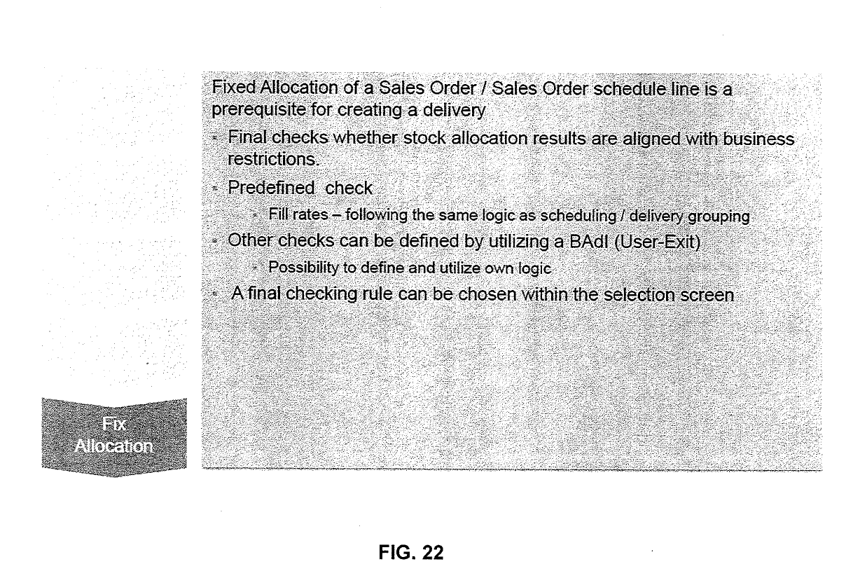

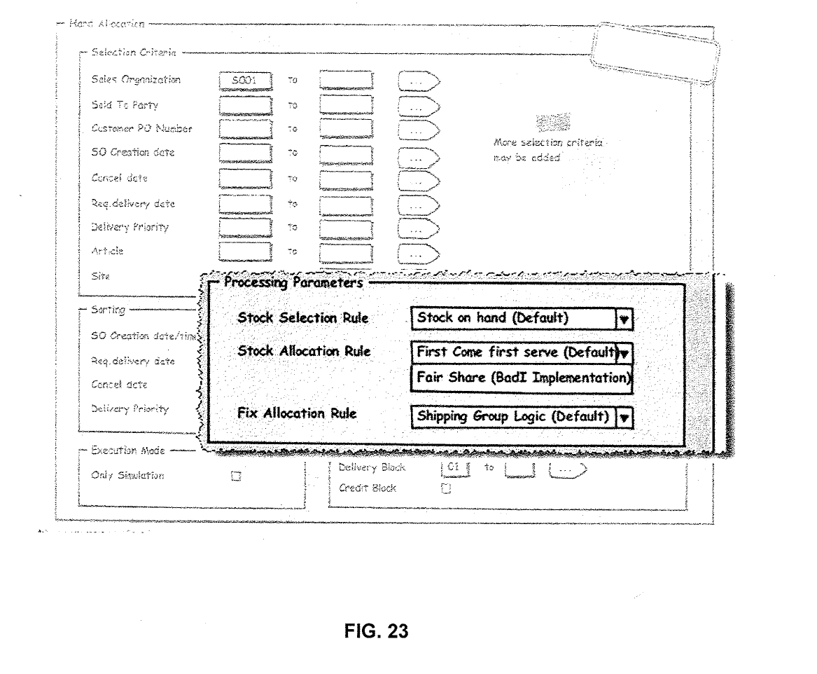

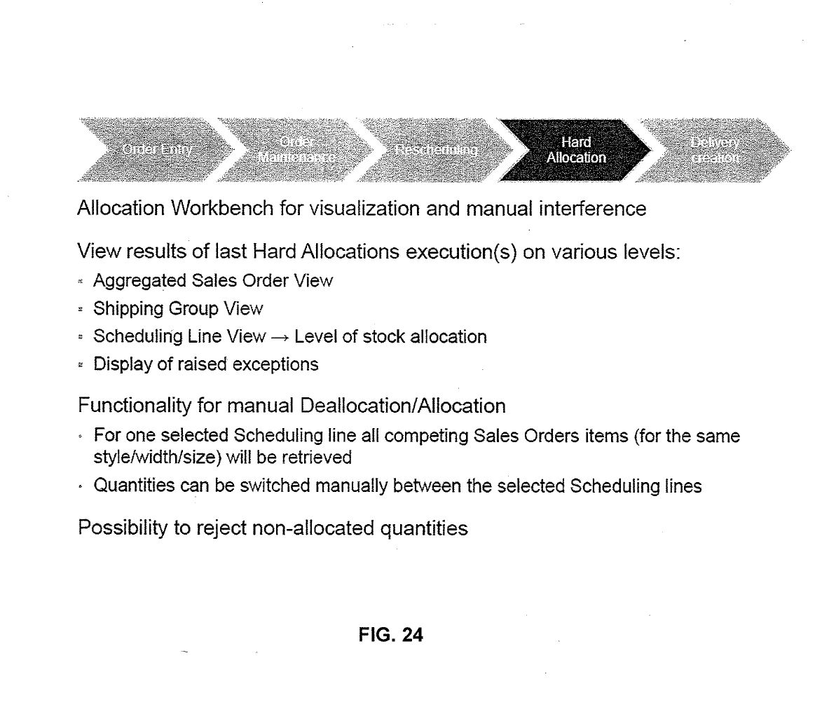

FIG. 8 shows that the fashion retail allocation may implement a framework of an enterprise resource planning system's (e.g., SAP's ERP) allocation table modules for the purpose of allocation processing 810. The following features, functions and services of the allocation table framework (see, e.g., FIG. 14) are described below. For integration and document flow, the allocation table framework provides a seamless integration with the preceding planning and purchasing processes and the succeeding outbound delivery processing in logistics. A stable document flow is in place across the whole purchasing, allocation and logistics process chain. For recipient determination, the integration of custom-specific logic for the determination of stores and store clusters as allocation recipients is provided. As a consequence, fashion retailers may implement their own unique determination logic in order to find the appropriate recipients for each of the allocation scenarios (e.g., pre-allocation, initial allocation, replenishment, final clearance, and the like). The ACS automated store allocation may provide a pre-defined recipient determination that is based on a bottom-up search for store clusters in the article hierarchy. If applicable, further recipient determinations might be added to the portfolio of fashion retail allocation. Allocation strategies may represent the core calculation logic for determining the right allocation quantities for the right stores. Allocation strategies may follow either a top-down or a bottom-up principle (see FIG. 13).

For the determination of the allocation quantities, allocation strategies may be able to consult a variety of influencing factors, for example allocation parameters, allocation KPIs, size quotas, master data parameters, stock quantities, rounding rules, handling of remaining quantities, etc. Since these parameters and the underlying calculation logic vary from fashion retailer to fashion retailer, the allocation table module enables the implementation of custom-specific allocation strategies and their embedding into the automated and manual allocation process flow. A fashion retailer may implement tailored strategies for each of its allocation scenarios of the seasonal allocation cycle. Nevertheless, a pre-defined set of allocation strategies may be delivered with system 800. If applicable, this strategy portfolio is enhanced by fashion retail allocation together with the introduction of a new generation of allocation strategy technology. Automated allocation tools are provided, as noted herein.

A standard solution portfolio may provide the ability to extract key figures from a business warehouse (including, e.g., business intelligence) when executing an allocation strategy. But this integration functionality may be quite restrictive and is more or less limited to a single key figure.

Today's allocation strategies may be line item oriented, that is an allocation strategy is executed for each single style/color/size without having visibility/access to other sizes, colors of the same style. This line-by-line execution and the restriction to include only one single key figure from business intelligence are often not sufficient for the allocation business of fashion retailers. Therefore, fashion retail allocation may include one or more of the features noted below.

For example, a feature may be the allocation of colors, rollouts, programs, themes, and/or pre-packs. In a first step, system 800 may enable a fashion retailer to execute allocation strategies: for several sizes of the same style/color; for several colors of the same style; and/or for several styles. This may support a color-driven allocation business as it is shared by many fashion companies. With the access to all style/colors, quantity quotas may be determined on a color basis and finally broken down to the sizes by the usage of size quotas. Furthermore, styles that are within the same program/theme or that are currently rolled-out may be allocated within the same execution of an allocation strategy. This allows a balancing of allocation quantities for styles that do have some dependencies. For example, there is a new summer rollout of miniskirts and associated tops. Allocation may handle that both color and sizes of the allocated miniskirt and top styles are well counterbalanced.

The access of an allocation strategy to several allocation line items may also be used for handling pre-packs. In order to have some flexibility and space for logistics optimization (warehouse, shipping, etc.) fashion retailers typically order an article within several pre-packs, ratio packs and/or as single solid packs. This means that the same style/color/size is delivered as single item and as component of several packs. From a logistics point of view, the overall target is to maximize the usage of pre-packs and to avoid the necessity to open the pre-packs until the final goods receipt at the stores. In contrast, the right colors and sizes should be in the right stores from a sales perspective and there should not be a chaotic merchandise presentation for the shoppers because of overstocking. As such, some contrary objectives should be balanced by allocation. An allocation strategy may first determine the total available quantities for the style/color/size items by dissolving the pre-packs and adding the (component) quantities to the single item quantities. Then, the allocation quantity calculation may be done based on the single style/color and style/color/size items. Finally, a pre-pack determination and optimization logic may be executed based on the single item quantities in order to come-up with an allocation result that maximizes the shipment of the available pre-packs and thereby avoids the labor- and cost-intensive opening of pre-packs in the warehouse.

Another feature may be multiple key figures by seamless integration with allocation intelligence. The new allocation strategies may provide the extraction of several allocation parameters/KPIs as well as size quotas as they are residing in the allocation intelligence in business warehouse. New customizing dialogue(s) may be implemented that allow the pre-configuration of which allocation parameter/KPI should be used by which allocation strategy and in which allocation scenario.

Yet another feature relates to allocation strategy types. For example, system 800 may be executed by automated allocation 820 and by the allocation workbench 830 on the different levels of multi-level allocation. Therefore, input and output quantities of an allocation strategy may target different allocation sender and recipient levels. For example, typically, the execution of an allocation strategy by automated allocation determines the allocation quantity at style/color/size and store level. The usage of allocation strategies by multi-level allocation might proceed in a more step-wise and top-down approach. As an example, the execution of a strategy at style level may first deliver some allocation quantities at style/color and store cluster level based on the weighted and averaged KPIs of the stores within a store cluster. After reviewing and adjusting the quantities at style/color and store cluster level, the merchandiser triggers another allocation strategy that refines the temporary allocation results down to the style/color/size and store level by applying some size quotas and additionally taking into account some store priorities. Consequently, there are different varieties of allocation strategies that are asking for the introduction of allocation strategy types together with flexible configuration mechanisms in order to fine-tune the strategy usage by different allocation purposes, scenarios, and tools.

Yet another feature relates to simplified implementation of allocation strategies for the implementation of its own allocation strategies, a fashion retailer should be able to concentrate only on calculation instead of data extraction. The framework of the allocation strategies is responsible for the data delivery based on a flexible configuration network. The customer should only have to code the pure calculation rules on the delivered data sources. There may also be provided a high degree of reusability of already implemented strategies since the strategies of different allocation scenarios often only differ in the used allocation parameters/KPIs but do share the same calculation logic. KPIs and allocation parameters should be substituted easily by configuration within the allocation strategies. In order to relieve the implementation of custom-specific allocation strategies, a fashion retail allocation may also deliver some templates/defaults/examples for each of the allocation strategy types.

In some implementations, the allocation intelligence 840 may include size curves 852, allocation KPIs 854, and allocation parameters 856. Size curves 852 represent quota values of sizes on the total sales of a group of articles sharing the same size category. Typically, they are calculated at store or store cluster level and they are based on a sufficient series of historical/actual sales data for articles that are belonging to the same node of the article hierarchy and that are having the same size structure. Therefore, size curves represent a reliable reflection of the size shopping behavior of the consumers for a single store or group of stores. The knowledge of the size shopping quotas of previous seasons is an aspect of an accurate planning and allocation of new merchandise in subsequent seasons.

Allocation KPIs 854 are benchmarks and indicators for the merchandiser in order to verify the progress, performance, or degree of fulfillment for important objectives or critical success factors of allocation. Apart from that, allocation KPIs are also used within the allocation quantity calculations, as they are capsulated in the allocation strategies. As sketched in FIG. 8, allocation KPI values may be calculated based on various input parameters like sales data, planning data, movement data (for example goods movements, stock transfer orders, outbound deliveries, purchase orders), stock quantities, allocation parameters (see section 3.4.3) and master data attributes. Either they are explicitly stored in a business warehouse information provider or they are calculated on the fly by executing an appropriate query. Some examples for allocation KPIs in the area of allocation include: open-to-ship (OTS), open-to-receive (OTR), average weekly sales, total sales of former season, store plan, and/or sell through percentage. Each fashion retailer may have its own set of favorite allocation KPIs.

In comparison to allocation KPIs 854, allocation parameters 856 are slightly more static and are mainly used by the calculation logic of the allocation strategies in order to come-up with accurate store allocation quantities for each style/color/size. Allocation parameters 856 may be manually maintained but may also be supported by semi- or fully-automated calculation engines. Typical examples for allocation parameters are the following attributes: target weeks of supply; minimum or maximum store inventory; minimum or maximum allocation quantity; minimum or maximum percentages of overall merchandise stock; allocation quotas; store blocking or pausing indicators; selling a class; replenishment mode indicators, for example accelerating, normal, decelerating; and store capacity.

Many fashion retailers request a flexible maintenance user interface for allocation parameters. Even if parameters are fully or semi-automatically calculated value maintenance or overruling may be configured at different levels for the article hierarchy, for single style/color or style/color/size combinations, and/or for single stores, store clusters, regions, countries, or the whole company.

Value determination logic at system 800 may be used at the time when allocation is processed. Often, a style/store combination that is currently under allocation represents the starting point for such determination logic. The data maintenance hierarchy for the requested allocation parameter has to be walked through based on a bottom-up search logic starting with finest level until a valid entry is found. The scope of fashion retail allocation envisions a template for the allocation parameter maintenance together with the appropriate determination logic. This template may be represented by a planning layout based on which several allocation parameters may be manually maintained on an underlying article/store hierarchy. This exemplary business warehouse content should be re-usable, easy-to-adapt, and easy-to-enhance for a concrete customer scenario.

The following describes example embodiments related to multichannel order allocation.

In today's wholesale and retail business, many companies are targeting a multi-channel approach for selling their goods and services. These multiple sales channels may include a retailer's own so-called “brick and mortar” stores, on-line stores, wholesale channels, mobile sales channels (e.g., mobile phone-based sales channels), franchise sales, and vendor manager inventory controlled customer channels. This breadth of channels may require high visibility and complex merchandise distribution tools across the sales channels. The various stock demands out of the individual channels have to be fulfilled in such a manner that the overall business targets (for example revenue/margin/customer satisfaction goals) and KPIs (Key Performance Indicators) of the company are achieved.

Moreover, in a constrained stock situation in which not all demands for a given item may be fulfilled, merchandise distribution and order allocation mechanisms may be configured to provide flexibility in order to come up with a result that is close to the optimal what still may be achieved under the given circumstances. Such circumstances are not only caused by a higher customer and/or end consumer demand as originally planned but also by exceptional events that are not under the control of the company (e.g., truck or warehouse accidents, partial deliveries or shipment shortages by the vendor, bad quality merchandise as delivered by the vendor, and/or belated arrival of new merchandise from the supplier).

Thus, systems 100 and/or 800 may be used to provide alternatives/action items of how to respond to such unexpected events. Moreover, the restricted available stock may be allocated based on the demands out of the various sales channels with the help of appropriate order allocation business strategies. An order allocation strategy may follow some pre-defined business rules in rules 192 (e.g., fair share prioritization rules, and the like) that guide the allocation of the limited stock to the higher demands. For example, the rules may be configured to allocate orders to channels such that the demands out of the own stores and web/online channel have higher priority than those one out of the franchise/vendor managed inventory (VMI channels. Another rule might prioritize the wholesale channel since this typically represents a powerful sales channel. Furthermore, a rule may define a retail/wholesale company as having some top priority customers in the wholesale channels that should receive allocations before others. For these top priority customers, their demand may always be allocated and only the remaining stock is then allocated to the other customers based on some more refined business rules for the wholesale channel.

Systems 100 and/or 800 may thus be configured to provide a solution for automatically allocating merchandise/goods in constrained/competitive stock situations over the demands out of various sales channels and thereby clearly following pre-defined business rules at rules 192 that are representing the companies' business goals. Although the following describes the multichannel order allocation implemented at system 100, multichannel order allocation may also be implemented in other systems as well including system 800.

The multichannel order allocation module 182 at FIG. 1 may be configured to flexibly fulfill orders across channels in accordance with rules 192. The multichannel order allocation module 182 may perform a so-called hard-allocation, providing pre-defined anchor points to retail/wholesale companies where they may attach, fine-tune, and/or customize dedicated business rules 192.

The rules 192 may be configured to determine which demands to take into account, which sales channels should be fulfilled, which channels should be given priority for fulfillment, and which individual demands of a sales channel should participate in an order allocation processing (e.g., only demands in a certain time window, originating from certain countries or sales organization and only assigned to a certain product group, etc.). The rules may also be configured to prioritize based on channels, customers, delivery date, order date, customer priority, type of items being ordered, and the like. Available stock that may be allocated to customers and channels may be restricted based on various configuration criteria that are encapsulated as a so-called “stock selection rule,” which are also stored in rules 192. The stock selection rules may be configured to select stock based on whether stock is available, on-order, unrestricted, restricted (e.g., limited availability stock), and the like.

The rules 192 may also be configured to determine how to split available stock over multiple orders (also referred to as requests, demands, and the like). For example, a constrained, or restricted, stock may be allocated based on a rule, such as first come first served, fair share allocation, and the like.

The rules 182 check whether the allocation results are consistent with business rules. For example, a set of rules may be designated as “fix allocation rules” to enable a retail/wholesale company to set-up some business rules that are verified just after the allocation of quantities. Only if the allocated demands fulfill these fix allocation rules (e.g., fill rates, shipping window, maximum number of shipments, etc.) then they are allowed to be released to the logistics execution in the warehouse.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

Although a few variations have been described in detail above, other modifications are possible. For example, while the descriptions of specific implementations of the current subject matter discuss analytic applications, the current subject matter is applicable to other types of software and data services access as well. As used herein, the phrase “based on” includes “based on at least.” Furthermore, the term “module” may refer to at least one memory including code which may be executed by at least one processor. Moreover, although the above description refers to specific products, other products may be used as well. In addition, the logic flows depicted in the accompanying figures and described herein do not require the particular order shown, or sequential order, to achieve desirable results. Other embodiments may be within the scope of the following claims.

1. A non-transitory computer-readable medium containing instructions to configure a processor to perform a method, the method comprising:
receiving, at a shipping groups module, a sales order for at least one article;
processing, at the shipping groups module, the sales order to determine at least one shipping group based on at least one of a plurality of rules obtained from a rules module, wherein the processing includes allocating the at least one article in the sales order based on allocation of at least another article; and
generating a shipping order including the at least one determined shipping group.

2. The computer-readable medium of claim 1, wherein the processing further comprises:
processing each line item of the sales order to determine the at least one shipping group.

3. The computer-readable medium of claim 1, wherein the processing further comprises:
determining the at least one shipping group based on a fill rate.

4. The computer-readable medium of claim 1, wherein the processing further comprises:
applying the at least one of the plurality of rules to the at least one shipping group.

5. The computer-readable medium of claim 4, wherein the at least one of a plurality of rules comprises at least one of a minimum number of days between shipments and a maximum number of shipments.

6. The computer-readable medium of claim 4, wherein the processing further comprises:
determining whether the at least one rule in the plurality of rules is violated;
modifying, based on the determining, the at least one shipping group.

7. A system comprising:
at least one processor; and
at least one memory including code which when executed by the at least one processor provides operations comprising:
receiving, at a shipping groups module, a sales order for at least one article;
processing, at the shipping groups module, the sales order to determine at least one shipping group based on at least one of a plurality of rules obtained from a rules module, wherein the processing includes allocating the at least one article in the sales order based on allocation of at least another article; and
generating a shipping order including the at least one determined shipping group.

8. The system of claim 7, wherein the processing further comprises:
processing each line item of the sales order to determine the at least one shipping group.

9. The system of claim 7, wherein the processing further comprises:
determining the at least one shipping group based on a fill rate.

10. The system of claim 7, wherein the processing further comprises:
applying the at least one of the plurality of rules to the at least one shipping group.

11. The system of claim 10, wherein the at least one of a plurality of rules comprises at least one of a minimum number of days between shipments and a maximum number of shipments.

12. The system of claim 10, wherein the processing further comprises:
determining whether the at least one rule in the plurality of rules is violated;
modifying, based on the determining, the at least one shipping group.

13. A non-transitory computer-readable medium including code which when executed by at least one processor provides operations comprising:
receiving, at a shipping groups module, a sales order for at least one article;
processing, at the shipping groups module, the sales order to determine at least one shipping group based on at least one of a plurality of rules obtained from a rules module, wherein the processing includes allocating the at least one article in the sales order based on allocation of at least another article; and
generating a shipping order including the at least one determined shipping group.

14. The non-transitory computer-readable medium of claim 13, wherein the processing further comprises:
processing each line item of the sales order to determine the at least one shipping group.

15. The non-transitory computer-readable medium of claim 13, wherein the processing further comprises:
determining the at least one shipping group based on a fill rate.

16. The non-transitory computer-readable medium of claim 13, wherein the processing further comprises:
applying the at least one of the plurality of rules to the at least one shipping group.

17. The non-transitory computer-readable medium of claim 16, wherein the at least one of a plurality of rules comprises at least one of a minimum number of days between shipments and a maximum number of shipments.

18. The non-transitory computer-readable medium of claim 16, wherein the processing further comprises:
determining whether the at least one rule in the plurality of rules is violated;
modifying, based on the determining, the at least one shipping group.
